(19) United States
(12) Patent Application Publication
(10) Pub. No.: US 2023/0073169 A1
(43) Pub. Date: Mar. 9, 2023

(54) IMPROVED WORKBENCH

(71) Applicant: HSIGN S.R.L., Monte Giberto (IT)

(72) Inventor: Anna Luisa CIMADAMORE, Fermo (IT)

(73) Assignee: HSIGN S.R.L., Monte Giberto (IT)

(21) Appl. No.: 17/904,197

(22) PCT Filed: Feb. 14, 2020
(86) PCT No.: PCT/IB2020/051251

§ 371 Date: Aug. 12, 2022

(51) Int. Cl. A47B 13/12; A47B 83/04; A47B 13/16; A47G 7/04; G02F 1/137

(52) U.S. Cl. CPC A47B 13/12; A47B 83/045; A47B 13/16; A47G 7/041; G02F 1/137; A47B 2200/06; A47B 2200/12; A47B 2200/0079; A47B 2200/0073

(57) ABSTRACT

An improved multifunctional workbench which comprises a desk element and one or more storage compartments, configured for housing documents, located under it. The desk element is made, at least partially, of a material presenting variable light transmission properties, such that it can selectively pass from a transparent configuration to an opaque configuration. Advantageously, the workbench allows to keep the desk, which is normally full of documents, clean, because makes visible the documents stored in the storage compartments below it selectively. Otherwise, it is possible to keep such documents hidden when necessary, for privacy reasons.

At today, the request for office workplaces which are able to offer an ergonomic and comfortable working environment, also possibly of economic realization, is continuously increasing.

Facing this technical problem, a multi-functional workbench configured in order to improve the working performance of a user has been developed.

More in detail, a proactive, ergonomic, modular workbench, equipped with artificial intelligence and technologies capable of rebalancing anxiety and stress, improving concentration, stimulating creativity by facilitating productivity of a user, is herein provided.

The goal that led to the creation of the workbench according to the present invention was to add new dimensions to the traditional workplaces, considering the psychological, physiological and emotional dynamics that reside in the interaction between colleagues in the same office.

Also, the emotions linked to the specific user's workplace have been considered, which add emotional proactivity to the dimensions of design/ergonomics and functionality, and valued as ingredients essential to improve efficiency and motivation in every member of a working team.

It has been observed by the experts, that the best working results are achieved when a worker is included in a group wherein stress, discomfort and negative energies are eliminated—essential to work better and in sync—to establish profitable collaborative relationships and to be truly satisfied with the working activity. Such an approach allows rebalancing not only the internal dynamics of the group, but satisfies its members on the emotional, psychological and physical level, such that each worker does what is best for himself and for the group.

The working environment, in particular the workbench, give a key contribution in the determination of stress condition of the workers. For example, one of the environmental aspects having the most negative impact to the worker's emotions is the presence of a lot of documents and disordered papers on the desk.

A workbench aimed to overcome such a drawback is defined in independent claim 1.

Preferred features of the invention are recited in the dependent claims.

The workbench according the present invention comprises a desk element and one or more storage compartments, configured for housing documents, located under it. The desk element is made, at least partially, of a material presenting variable light transmission properties, such that it can selectively pass from a transparent configuration to an opaque configuration.

Advantageously, the workbench allows to keep the desk, which is normally full of documents, clean, because makes visible the documents stored in the storage compartments below it selectively. Otherwise, it is possible to keep such documents hidden when necessary, for privacy reasons.

The switch form one configuration of the desk element to another is controlled by means of a user interface device, connected to a control unit comprised in the same workbench.

According to preferred aspects of the invention, the workbench further comprises accessory devices, such as: a multifunction audio system, in particular configured for emitting bi-natural sound frequencies (for sending frequency stimuli to the user); an essence emitter for olfactory stimuli; an infrared camera, configured to allow the control unit to acquire biometric data of the user, associated with a user's psycho-emotional state, and take decisions on what type of combined stimuli (olfactory, auditory, frequency) are to be used in order to improve the mood of the person. Also, an air ionizer device could be comprised in the workbench.

Furthermore, according to a most preferred aspect of the invention, a microphone system for voice command of all the above-mentioned devices is provided.

Other embodiments of the invention provide the presence of a sound-absorbing back wall, with customizable backdrop, provided with the preferred colors and symbols of the person who will work at the considered workbench.

In addition, an ergonomic monitor, such as a 4 k curved monitor in 32:9 SuperWide (diagonal 48.8″/124 cm), Dual Quad HD (5120×1440), could be included in the workbench.

Advantageously, according to another aspect of the invention, all the furnishings are mainly composed of wooden panels, in order to realize a ‘green’ or ecological workbench. Preferably, LEB Ecological Panel made of 100% recycled wood, that is, with FSC (Forest Stewardship Council) post-consumer woody material, is used. It means that to make the Ecological Panel, no trees have been cut down. In addition, LEB is the panel in the best formaldehyde emission class in the world, with values 5 times lower than the E1 panel. An innovative lacquering system is used, which reduces the emission of harmful substances into the environment by up to 95% compared to traditional solvent-based paints. In addition, one-component water-based paints, fully complying with the EN71.3 standard and guaranteed to have zero aldehyde content, are used.

According to another advantageous aspect of the invention, a ‘green area’ is integrated in the workbench, thanks to the presence of a vase element. The presence of green plants, in addition to offering a positive impact on mood of the worker, contributes to the absorption of electromagnetic frequencies and CO₂.

According to another preferred embodiment of the invention, the control unit runs a software based on an artificial intelligence system, that makes the workbench react in a proactive way to the data collected form the user, or worker. Preferably, the artificial intelligence system can be put into active or standby mode simply with a voice command from the user.

When the artificial intelligence system is active, it controls the activation of the auxiliary devices already mentioned according to preferences set during a setup phase of the system performed by the user. Furthermore, the artificial intelligence system monitors the user's psycho/physical/emotional state instant by instant by processing the user's biometric data, and ensures that he is always in a balanced situation, correcting abnormal situations using predetermined multisensory stimuli (binaural sound frequencies, olfactory frequencies, ions, etc.).

In addition, the artificial intelligence system is preferably programmed to record over time the psycho-emotional responses of the user to the stimuli delivered, increasingly refining the type and composition of the stimuli to improve the beneficial effects on the user.

The user of each workstation according to the invention, managed by such an artificial intelligence system, is able at any time to ask for support to a contingent situation by means of the user interface (e.g. ask for multisensory stimuli for greater focus and concentration to carry out a demanding task, or ask for sensorial stimuli to be more creative when you are looking for ideas).

Thanks to its design and technical equipment, preferred embodiments of workbench according to the present invention are particularly effective for meetings with public and group meetings with colleagues.

Advantageously, the artificial intelligence system that manages every technological component installed in the workbench is able to synchronize all the monitors on a workbench network, to allow video meeting presentations with screen and audio shared from any workstation to the others of the network.

### BRIEF DESCRIPTION OF THE DRAWINGS

Reference will be made to the figures of the annexed drawings, wherein:

FIG. 1 shows a perspective view of a preferred embodiment of a workbench according to the present invention, in particular two workbenches reciprocally connected are shown;

FIG. 2 shows a schematic block diagram representing a preferred embodiment of a bar element comprises in a preferred embodiment of workbench according to the claimed invention; and

FIG. 3 shows a perspective view of a plurality of workbenches according to FIG. 1, connected to each other.

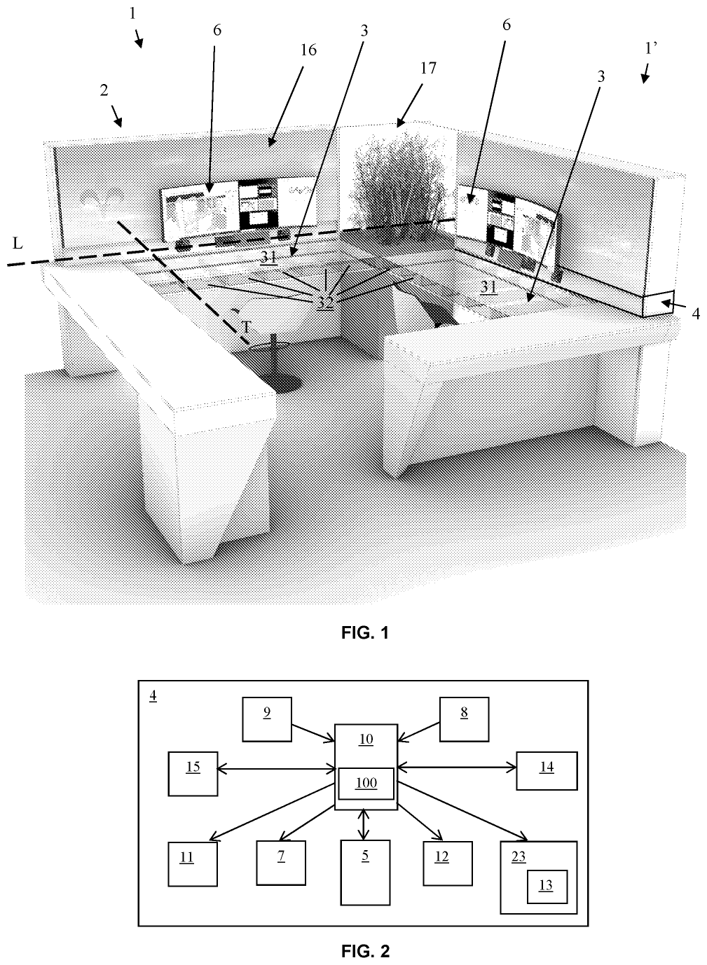

The above-mentioned Figures are to be meant exclusively by way of example and not for limitative purposes.

### DETAILED DESCRIPTION OF PREFERRED EMBODIMENTS OF THE INVENTION

With reference to FIG. 1, a workbench according to a preferred embodiment of the present invention is globally denoted by 1. In FIG. 1, another workbench according to the invention is shown, connected to the workbench 1 and denotated by the reference number 1′. In the following description, reference will be made indifferently to workbench 1 or 1′, but the considerations disclosed could be considered applied to both the workbenches 1, 1′, because they referred to the same embodiment.

As will be appreciated in the following, the workbench 1 is configured for exploit one or more, preferably a plurality of, functionalities in order to improve the user working experience.

A preferred embodiment of workbench 1 according to the invention comprises a table structure 2, which includes a desk element 3 and one or more storage compartments 32 located under the desk element 3. The desk element 3 preferably comprises a planar working surface 31 extending according to a longitudinal direction L and to a transversal direction T. The storage compartments 32 are shaped for housing documents, books, paper items and stationery items in general.

The storage compartments 32 are preferably realized in a transparent material, such as transparent glass or plastic.

The desk element 3 is made, at least partially, of a material presenting variable light transmission properties in function of the application of predetermined values of light, voltage, or heat.

Such kind of material could comprise, for example, laminated glass preferably provided with two glasses, more preferably extra-clear glasses, and an LCD liquid crystal film inserted between two EVA or PVB sheets. Extra-clear glass is colorless, transparent and provides a very clear view, for example thanks to a very low content of iron oxide.

More in general, the glass material of the desk element 3 can be realized applying smart glass technologies and solutions already known in the state of the art, such that electrochromic, photochromic, thermochromic, suspended-particle, micro-blind, and polymer-dispersed liquid-crystal.

Therefore, the configuration of the desk element 3 is such that it can selectively pass, at least, from a transparent configuration to an opaque configuration. In particular, in the transparent configuration, the desk element 3 allows passage of all wavelengths of light, whereas, in the opaque configuration, the desk element 3 absorbs all wavelengths of light.

The above desk element 3 configuration selectively allows the user to look through, or not, the desk element 3 itself.

According to another embodiment of the invention, the desk element 3 is configured to assume further a translucent configuration, that is a configuration wherein the desk element 3 absorbs only some wavelengths of light.

In order to change the configuration of the desk element 3, that is changing its light transmission properties, the workbench 1 comprises a dedicated activation device 7. The activation device 7 is connected to the desk element 3 and is configured such to selectively apply to the material of which the desk element 3 is composed first, second or third predetermined values of light, voltage, or heat.

The above mentioned first, second and third predetermined values respectively corresponding to a transparent, translucent and opaque configuration of said desk element 3. The possibility to select one of the above configurations allows the user to choose if the content of the storage compartments 32 should be visible or not through the desk element 3, in order to be hidden or not.

According to a preferred embodiment of the invention, the workbench 1 further comprises a control unit 10 connected to the activation device 7, and preferably to a user interface 5.

In the embodiment of workbench provided with the user interface 5, the latter is connected to the control unit 10 and configured for allowing the selection of a transparent, translucent or opaque configuration of the desk element 3 by a user.

Thanks to the above configuration, the desk element 3 of workbench 1 could be free from papers, but all work documents stored in the storage compartments could be selectively in view.

Other preferred embodiments of the invention provide the presence of one or more accessory devices, configured to improve the functionalities offered to the user. In fact, the workbench 1 could further comprise a microphone 8 connected to the control unit 10 and configured for collecting vocal commands of a user. Of course, the control unit 10 shall be programmed in order to be able to process predetermined vocal commands, according to technology solutions already known in the art.

According to further preferred embodiments, the workbench 1 comprises a camera 9 configured for detecting data referred to biometric parameters of a user sitting in front of said desk element 3 and transmitting such data to the control unit 10. According to this implementation, the control unit 10 is programmed to process the detected data in order to control the activation of further accessory devices for delivery essences and/or sounds as a function of the data received. In particular, the workbench 1 could comprise devices for the delivery of essences 11 and/or devices for the emission of sound stimuli 12 (in particular according to bi-natural sound frequencies), connected to the control unit 10.

In order to implement specific and different modes to activate such devices for the delivery of essences and/or the emission of sound stimuli 11, 12, the control unit 10 could be connected to a memory element 15, wherein associations between values of biometric data of the user and respective activation modes of said devices 11, 12 are stored. Preferably, it is further provided that such kind of association or the activation modes of the above devices 11, 12 could be set by means of the interface element 5, or by means of external electronic devices which can communicate directly with the control unit 10. According to the latter embodiment of workbench, a control unit comprising wireless means for exchanging data with external electronic devices should be provided.

Another embodiment of workbench 1 according to the invention comprises another auxiliary device such as an air ionizer 23, connected to said control unit 10 and provided with a device for the delivery of ionized air 13 at the desk element 3, in order to deliver the ionized air to the user during its work experience.

Preferably, the workbench control unit 10 could be provided with an artificial intelligence system 100 for the managing of the same workbench. When the artificial intelligence system 100 is active, it controls the activation of the auxiliary devices already mentioned according to preferences set during a setup phase of the system, performed by the user. Furthermore, the artificial intelligence system 100 monitors the user's psycho/physical/emotional state instant by instant by processing the user's biometric data collected by the camera 9, and ensures that he is always in a balanced ‘normal’ situation, correcting ‘abnormal’ situations using predetermined multisensory stimuli (binaural sound frequencies, olfactory frequencies, ions, etc.) by activating the above-mentioned accessory devices. The ‘abnormal’ situations are detected by artificial intelligence system 100 comparing the detected user's biometric data to predetermined user's biometric data set as data corresponding to ‘normal’ user conditions.

In addition, the artificial intelligence system 100 is preferably programmed to record in the memory element 15 the biometric data detected from the user which corresponds to the response of the user to the stimuli emitted by the workbench, increasingly refining the type and composition of the stimuli to improve the beneficial effects on the user.

According to a more preferred embodiment of the invention, the above described control unit 10, activation device 7, user interface 5, microphone 8, devices for the delivery of essences 11, device for the emission of sound stimuli 12, camera 9, memory element 15, and/or device for the delivery of ionized air 13 are comprised in a unique hardware element, such as a bar element 4 (shown in FIG. 1). The bar element 4 is preferably arranged at a top rear part of the desk element 3, as shown in FIG. 1, with reference to the workbench 1′.

The workbench 1 could further comprise a soundproofing panel 16 at a top rear part of the desk element 3, and/or an ergonomic monitor 6 arranged at the planar working surface 31 of the desk element 3. Preferably, the bar element 4 is arranged below the soundproofing panel 16 and behind the ergonomic monitor 6.

Preferred embodiments of the invention furthermore provide the presence of a vase element 17 configured for housing plants, arranged at a lateral side of said desk element 3.

Preferably, the above-mentioned desk element 3, bar element 4, soundproofing panel 16, ergonomic monitor 6 and/or vase element 17 are realized as a unique integrated structure. According to such an embodiment, the workbench 1 is realized as an integrated, monolithic structure, wherein the integrated structure could not be disassembled.

Otherwise, the invention provides embodiments of workbench realized as a modular structure, wherein the above-mentioned desk element 3, bar element 4, soundproofing panel 16, ergonomic monitor 6 and/or vase element 17 are realized as singular modular elements, configured to be selectively and detachably connected to each other.

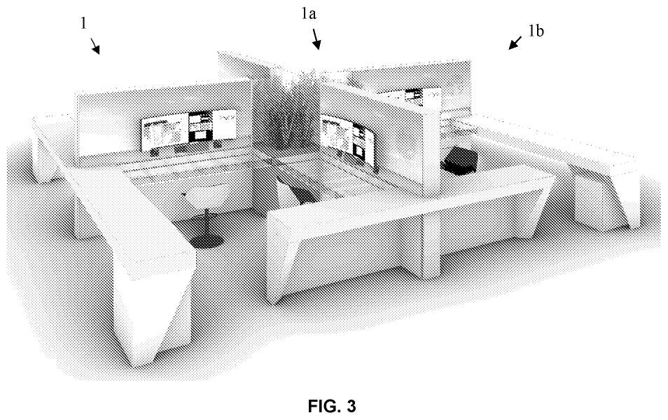

With reference to FIG. 3, the invention further provides a system comprising two or more workbenches 1, 1a, 1b according to any of the embodiments already described, which are provided with connection elements in order to be selectively and detachably connected to each other. According to this latter embodiment, preferably the vase elements is inserted at a corner position interposed between two workbenches, to optimize the positive effects of the plants for both the users of the two workbenches.

Advantageously, each of said workbenches 1, 1a, 1b could comprise an interphone system 14 for communication to the other one or more workbenches.

The present invention has been described so far with reference to preferred embodiments, which are intended to be combined if compatible. It is intended that there may be other embodiments which refer to the same inventive concept and fall within the scope of the appended claims.

1. A workbench comprising:
a table structure, comprising: (1) a desk element, comprising a planar working surface extending according to a longitudinal direction and to a transversal direction, and (2) one or more storage compartments located under said desk element,
said desk element being made, at least partially, of a material presenting variable light transmission properties in function of the application of predetermined values of light, voltage, or heat,
wherein said desk element presents a configuration such that it can selectively pass from a transparent configuration to an opaque configuration, wherein:
in the transparent configuration, said material allows passage of all wavelengths of light, and
in the opaque configuration, said material absorbs all wavelengths of light,
in order to selectively allow to see, or not, the content of said one or more storage compartments through said desk element.

2. The workbench according to claim 1, wherein said desk element is configured to assume a further translucent configuration, wherein said material absorbs only some wavelengths of light.

3. The workbench according to claim 1, wherein said material comprises laminated glass provided with two extra-clear glasses and an LCD liquid crystal film inserted between two EVA or PVB sheets.

4. The workbench according claim 1, comprising an activation device of said desk element, said activation device being configured to selectively apply, to said material, first, second and third predetermined values of light, voltage, or heat,
said first, second and third predetermined values respectively corresponding to a transparent, translucent and opaque configuration of said desk element.

5. The workbench according to claim 4, comprising a control unit connected to said activation device and a user interface connected to said control unit and configured to allow the selection of a transparent, translucent or opaque configuration of the desk element by a user.

6. The workbench according to claim 5, comprising a microphone configured for collecting predetermined vocal commands of a user and connected to said control unit, wherein said control unit is programmed to process said predetermined vocal commands.

7. The workbench according to claim 5, comprising devices for the delivery of essences and/or devices for the emission of sound stimuli, connected to said control unit.

8. The workbench according to claim 7, comprising a camera configured for detecting data referred to biometric parameters of a user sitting in front of said desk element and transmitting said data to said control unit (10), wherein said control unit is programmed to process said data and control the activation of said devices for the delivery of essences or devices for the emission of sound stimuli as a function of the data received.

9. The workbench according to claim 8, wherein said control unit is connected to a memory element wherein associations between values of said data and respective activation modes of said devices for the delivery of essences or devices for the emission of sound stimuli are stored.

10. The workbench according to claim 5, comprising an air ionizer provided with a device for the delivery of ionized air at said desk element, connected to said control unit.

11. The workbench according to claim 4, wherein said activation device, control unit, user interface microphone, devices for the delivery of essences, devices for the emission of sound stimuli, camera, memory element or said device for the delivery of ionized air is/are comprised in a bar element.

12. The workbench according to claim 11, wherein said bar element is arranged at a top rear part of said desk element.

13. The workbench according to claim 1, comprising a soundproofing panel arranged at a top rear part of said desk element.

14. The workbench according to claim 1, comprising an ergonomic monitor arranged at said planar working surface of said desk element.

15. The workbench according to claim 1, comprising a pot element configured for housing plants, arranged at a lateral side of said desk element.

16. The workbench according to claim 12, wherein said desk element, soundproofing panel, ergonomic monitor or pot element are realized as a unique integrated structure.

17. A system comprising two or more workbenches each according to claim 1, wherein each of said two or more workbenches comprises an interphone system for communication to the other one or more workbenches.
